(19) United States
(12) Patent Application Publication
(10) Pub. No.: US 2014/0157977 A1
(43) Pub. Date: Jun. 12, 2014

(54) CYLINDER MECHANISM

(71) Applicants: HON HAI PRECISION INDUSTRY CO., LTD., New Taipei (TW); HONG FU JIN PRECISION INDUSTRY (ShenZhen) CO., LTD, ShenZhen (CN)

(72) Inventors: WEN-TAO WANG, Shenzhen (CN); XIAO-BING XU, Shenzhen (CN); JIAN-HUA YONG, Shenzhen (CN); MIAO-AN OU-YANG, Shenzhen (CN); JIAN-BIN KONG, Shenzhen (CN)

(73) Assignees: HON HAI PRECISION INDUSTRY CO., LTD., New Taipei (CN); HONG FU JIN PRECISION INDUSTRY (ShenZhen) CO., LTD, ShenZhen (CN)

(21) Appl. No.: 14/093,616

(22) Filed: Dec. 2, 2013

(30) Foreign Application Priority Data
Dec. 6, 2012 (CN) 2012105185880

(51) Int. Cl. F16J 1/04

(52) U.S. Cl. CPC F16J 1/04
USPC 92/15

(57) ABSTRACT

A cylinder mechanism includes a cylinder body assembly, a piston assembly, and a grasping assembly. The cylinder body assembly includes a cylinder body. The cylinder body defines a receiving cavity, a first gas hole, and a second gas hole. The first and second gas holes communicate with the receiving cavity. The piston assembly includes a piston movably received in the receiving cavity, a guiding shaft movably received in the receiving cavity, and a limiting member. A first end of the guiding shaft is fixed to the piston, and a second end defines a receiving groove. A pair of guiding hole is defined in the guiding shaft. The grasping assembly includes a pushing member movably received in the guiding shaft, a pin received through the guiding holes, and a latching member movably received in the guiding shaft and capable of protruding outward.

### BACKGROUND

1. Technical Field

The present disclosure relates to cylinders, and particularly to a cylinder capable of grasping a workpiece.

2. Description of Related Art

Cylinders are often used for transporting or positioning a workpiece. To prevent scratching surfaces of the workpiece, the cylinder uses grasping members mounted to a piston assembly to grasp an inner hole of the workpiece. However, the grasping members are mounted on an outer portion of the piston assembly, which causes the cylinder to occupy large space and have a complicated structure.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a cylinder mechanism.

FIG. 2 is an exploded, isometric view of the cylinder mechanism shown in FIG. 1.

FIG. 3 is a cross-sectional view of the cylinder mechanism taken along line III-III of FIG. 1.

FIG. 4 is a cross-sectional view of the cylinder mechanism taken along line IV-IV of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

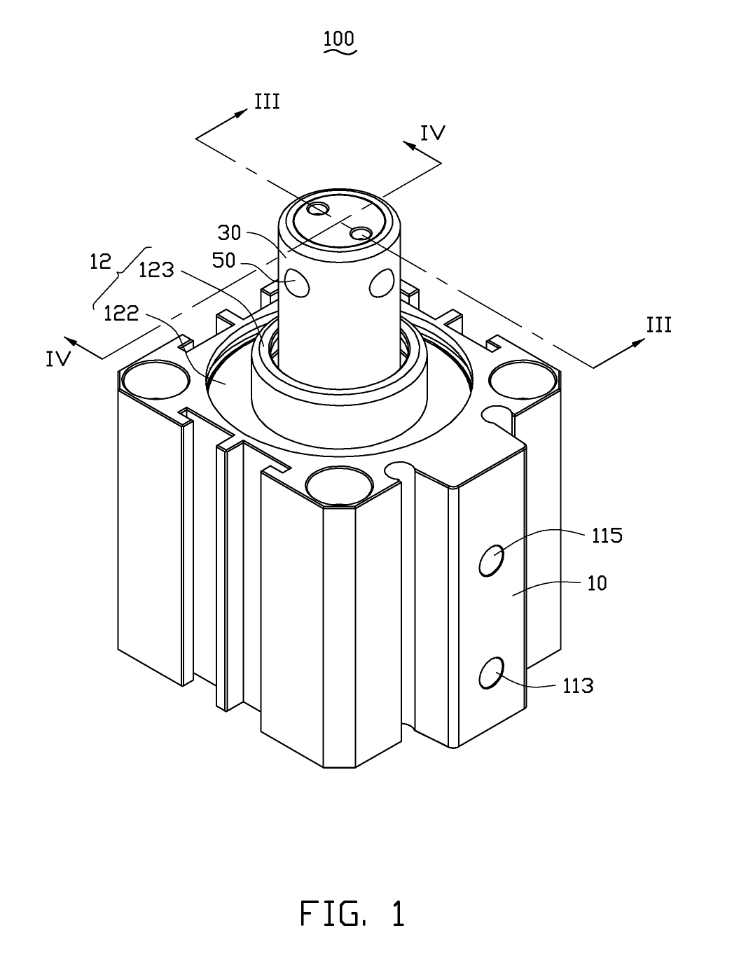

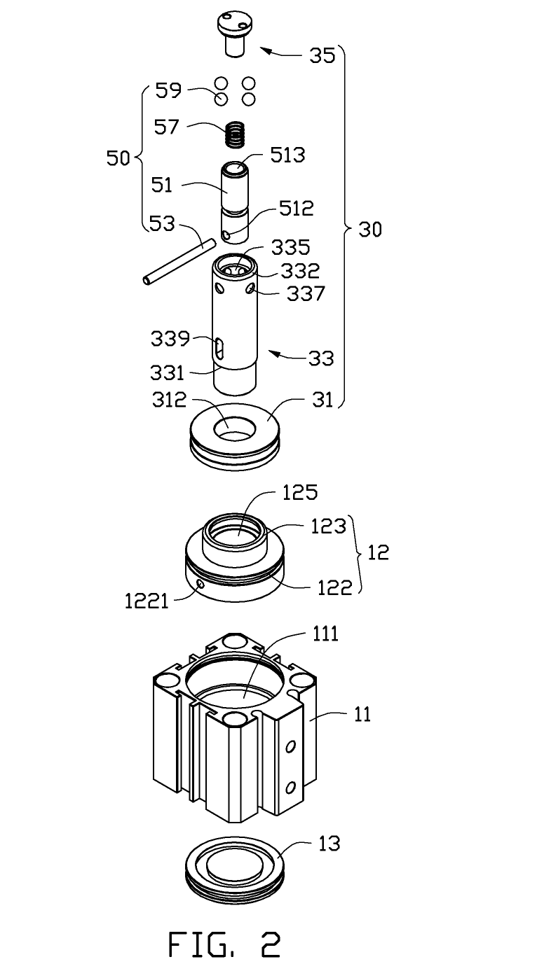

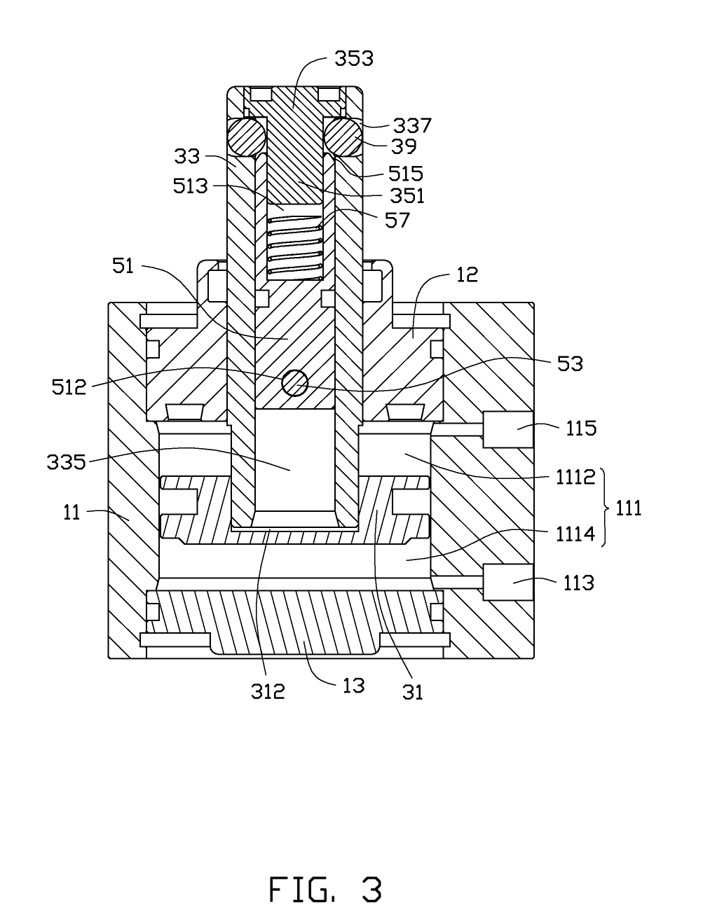

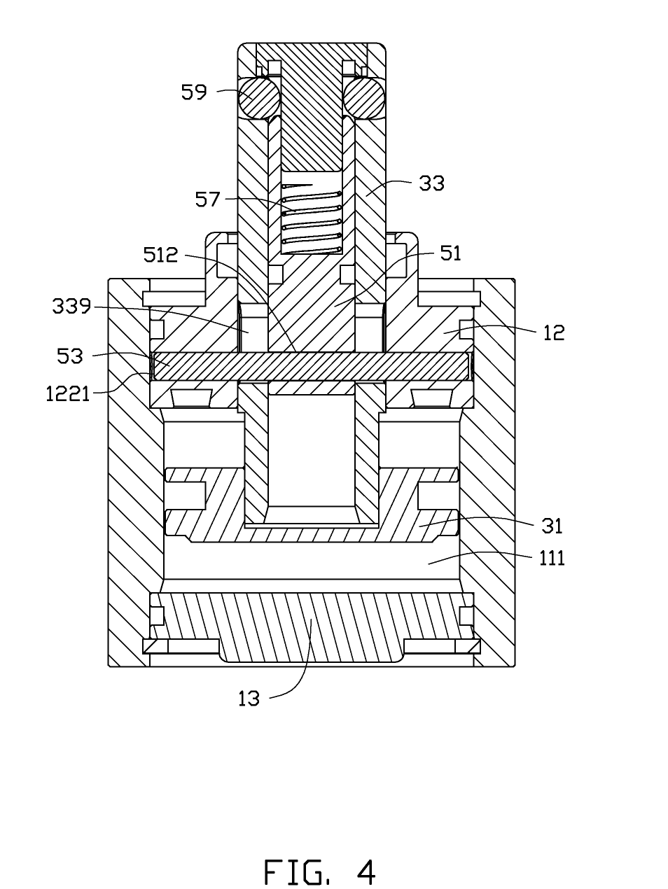

FIGS. 1 through 4 show an embodiment of a cylinder mechanism 100. The cylinder mechanism 100 includes a cylinder body assembly 10, a piston assembly 30, and a grasping assembly 50. The piston assembly 30 is movably received in the cylinder body assembly 10. The grasping assembly 50 is movably received in the piston assembly 30.

The cylinder body assembly 10 includes a cylinder body 11, a top cover 12, and a bottom cover 13. The top cover 12 and the bottom cover 13 are mounted to opposite ends of the cylinder body 11, respectively. The cylinder body 11 defines a receiving cavity 111, and further defines a first gas hole 115 and a second gas hole 113 in a sidewall thereof. The first gas hole 115 and the second gas hole 113 communicate with the receiving cavity 111 and are connected to two gas sources (not shown). The top cover 12 includes a fixing portion 122 and a guiding portion 123 extending from the fixing portion 122. The fixing portion 122 is received in the receiving cavity 111 and mounted to one end of the cylinder body 11. An extending hole 125 is axially defined through the fixing portion 122 and the guiding portion 123, such that the extending hole 125 communicates with the receiving cavity 111. The fixing portion 122 defines a pair of opposite fixing holes 1221 through a sidewall thereof. The fixing holes 1221 communicate with the extending hole 125. The guiding portion 123 protrudes out from the receiving cavity 111. The bottom cover 13 is substantially disk-like and mounted to another end of the cylinder body 11 opposite to the top cover 12 to seal the other end of the cylinder body 11.

The piston assembly 30 includes a piston 31, a guiding shaft 33, and a limiting member 35. The piston 31 is movably received in the receiving cavity 111 and located between the first gas hole 115 and the second gas hole 113, such that the receiving cavity 111 is divided into a first section 1112 communicating with the first gas hole 115 and a second section 1114 communicating with the second gas hole 113. A fixing groove 312 is axially defined in a central portion of the piston 31. The guiding shaft 33 is substantially hollow. The guiding shaft 33 is received through the extending hole 125 and partially received in the receiving cavity 111, such that a first end 331 of the guiding shaft 33 is fixedly received in the fixing groove 312, and a second end 332 of the guiding shaft 33 protrudes out from the extending hole 125. A sidewall of the guiding shaft 33 adjacent to the first end 331 defines a pair of opposite and elongated guiding holes 339. Each guiding hole 339 extends along a lengthwise direction of the guiding shaft 33. The second end 332 axially defines a receiving groove 335, and the sidewall defines a plurality of limiting holes 337 adjacent to the second end 332 and around a periphery thereof. A size of an outer portion of the limiting hole 337 decreases from an inner surface of the guiding shaft 33 to an outer surface of the guiding shaft 33. The limiting holes 337 communicate with the receiving groove 335. The limiting member 35 includes a connection portion 353 and a resisting portion 351 extending from the resisting portion 351. The resisting portion 351 is received in the receiving groove 335, such that the connection portion 353 is fixed to the second end 332.

The grasping assembly 50 includes a pushing member 51, a pin 53, an elastic member 57, and a plurality of latching members 59. The pushing member 51 is movably received in the receiving groove 335. A pair of positioning holes 512 is oppositely defined in a sidewall of the pushing member 51 and adjacent to an end thereof. The positioning holes 512 correspond to the pair of guiding holes 339. A receiving groove 513 is axially defined in one end of the pushing member 51 for receiving the connection portion 353. An oblique pushing surface 515 is formed around the end of the pushing member 51 defining the receiving groove 513. The pin 53 is received through the fixing holes 1221, the guiding holes 339, and the positioning holes 512. The elastic member 57 is received in the receiving groove 513, such that one end of the elastic member 57 resists against a bottom surface of the receiving groove 513, and an opposite end of the elastic member 57 resists against the resisting portion 351. The latching members 59 are each movably received in a corresponding limiting hole 337. When the pushing member 51 moves out of the guiding shaft 33, the pushing surface 515 resists against the lathing members 59, so that the latching members 59 partially protrude out from the limiting holes 337. In one illustrated embodiment, each latching member 59 is a steel ball. In other embodiments, the latching members 59 can be other shapes, such as cylindrical.

In assembly, the piston 31 is received in the receiving cavity 111. The guiding shaft 33 extends through the top cover 12, the pushing member 51 is received in the receiving groove 335 of the guiding shaft 33, and the pin 53 is received through the fixing holes 1221, the guiding holes 339, and the positioning holes 512. Next, the top cover 12 assembled with the guiding shaft 33, the pushing member 51, and the pin 53 is mounted on one end of the cylinder body 11. Then, the elastic member 57 is received in the receiving groove 513, and the latching members 59 are correspondingly received in the limiting holes 337. The resisting portion 351 is partially received in the receiving groove 513, such that the connection portion 353 is fixed to the second end 332, and opposite ends of the elastic member 57 resist against the resisting portion 351 and the bottom of the receiving groove 513, respectively. Finally, the bottom cover 13 is mounted on the other end of the cylinder body 12.

In use, the second end 332 of the guiding shaft 33 is inserted into a hole of a workpiece, and gas is fed into the receiving cavity 111 via the first gas hole 115, so that the piston 31 moves toward the bottom cover 13 under pressure from the gas. Because the pushing member 51 is fixed by the pin 53, the guiding holes 339 allow the guiding shaft 33, the latching members 59, and the limiting member 35 to move relative to the pushing member 51 toward the bottom cover 13, so that the latching members 59 resist against the pushing surface 515 to protrude outwardly, thereby resisting against an inner surface of the hole of the workpiece. Thus, the workpiece is grasped by the latching members 59. To release the workpiece, gas is stopped from feeding into the first gas hole 115 and flows out of the first gas hole 115, and gas is fed into the receiving cavity 111 via the second gas hole 113, so that the piston 31 moves toward the top cover 12 under the gas pressure. The guiding shaft 33, the latching members 59, and the limiting member 35 move relative to the pushing member 51 toward the top cover 12, and the latching members 59 are released by the pushing surface 515 from resisting the inner surface of the hole of the workpiece, thereby releasing the workpiece.

The pushing member 51, the elastic member 57, and the latching members 59 are received in the guiding shaft 33, and the guiding shaft 33 is received in the receiving cavity 111. Thus, the cylinder device 100 has a compact structure and takes up a reduced space.

In other embodiments, a number of the latching members 59 and the limiting holes 337 can be changed as required. The bottom cover 13 can be omitted, such that the cylinder body 11 has an integrated bottom cover portion. The elastic member 57 can be omitted, such that the bottom surface of the receiving groove 513 directly resists against the resisting portion 351.

While various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A cylinder mechanism, comprising:
a cylinder body assembly comprising:
a cylinder body defining a receiving cavity, a first gas hole, and a second gas hole, each of the first gas hole and the second gas hole communicating with the receiving cavity, and
a top cover fixedly mounted to one end of the cylinder body;
a piston assembly comprising:
a piston movably received in the receiving cavity between the first gas hole and the second gas hole,
a guiding shaft movably and partially received in the receiving cavity, a first end of the guiding shaft fixed to the piston and, a second end of the guiding shaft opposite to the first end axially defining a receiving groove, and a pair of guiding hole defined in a sidewall of the guiding shaft adjacent to the first end, and
a limiting member fixed to the second end of the guiding shaft; and
a grasping assembly comprising:
a pushing member movably received in the receiving groove,
a pin received through the pair of guiding holes and connecting the top cover, the guiding shaft and the pushing member, and
a latching member movably received in the guiding hole and configured to protrude out when resisting against one end of the pushing member.

2. The cylinder mechanism of claim 1, wherein one end of the pushing member comprises an oblique pushing surface, and the oblique pushing surface is formed around one end of the pushing member and configured to resist against the latching member.

3. The cylinder mechanism of claim 1, wherein the cylinder body assembly further comprises a bottom cover mounted to an end of the cylinder body which is opposite to the top cover.

4. The cylinder mechanism of claim 1, wherein the top cover comprises a fixing portion received in the receiving cavity and a guiding portion extending from the fixing portion, an extending hole is axially defined through the fixing portion and the guiding portion, the guiding portion protrudes out from the receiving cavity, and the guiding shaft is received in the receiving cavity via the extending hole and partially protrudes out from the guiding portion.

5. The cylinder mechanism of claim 4, wherein a pair of fixing holes is defined in a sidewall of the fixing portion, and opposite ends of the pins are received in the pair of fixing holes, respectively.

6. The cylinder mechanism of claim 1, wherein the grasping assembly further comprises an elastic member, the pushing member defines a receiving groove oblique adjacent to the pushing surface, the elastic member is received in the receiving groove of the pushing member, the limiting member is partially received in the receiving groove of the pushing member, and opposite ends of the elastic member resist against a bottom of the receiving groove of the pushing member and the limiting member, respectively.

7. The cylinder mechanism of claim 6, wherein the limiting member comprises a connecting portion and a resisting portion extending from the connection portion, the resisting portion is received in the receiving groove of the pushing member, and the connection portion is fixed to the second end of the guiding shaft.

8. The cylinder mechanism of claim 1, wherein the piston defines a fixing groove, and the first end of the guiding shaft is fixed in the fixing groove.

9. The cylinder mechanism of claim 1, wherein each of the pair of guiding holes is elongated.

10. The cylinder mechanism of claim 1, wherein the second end defines a limiting hole communicating with the receiving groove, and the latching member is movably received in the limiting hole.

11. The cylinder mechanism of claim 10, wherein a size of an outer portion of the limiting hole decreases from an inner surface of the guiding shaft to an outer surface of the guiding shaft.

12. A cylinder mechanism, comprising:
a cylinder body assembly comprising:
a cylinder body defining a receiving cavity, a first gas hole, and a second gas hole, each of the first gas hole and the second gas hole communicating with the receiving cavity, and
a top cover fixedly mounted to one end of the cylinder body;
a piston assembly comprising:
a piston movably received in the receiving cavity between the first gas hole and the second gas hole,
a guiding shaft movably and partially received in the receiving cavity, a first end of the guiding shaft fixed to the piston, a second end of the guiding shaft opposite to the first end defining a first receiving groove and a limiting hole communicating with the receiving hole, and a pair of guiding hole defined in a sidewall of the guiding shaft adjacent to the first end, and
a limiting member fixed to the second end of the guiding shaft; and
a grasping assembly comprising:
a pushing member movably received in the first receiving groove and defines a second receiving groove,
a pin passing through the pair of guiding holes and connecting the top cover, the guiding shaft and the pushing member,
an elastic member received in the second receiving groove, opposite ends of the elastic member resist against a bottom of the receiving groove and the limiting member, respectively, and
a latching member movably received in the limiting hole and configured to protrude out when resisting against one end of the pushing member.

13. The cylinder mechanism of claim 12, wherein the end of the pushing member comprises an oblique pushing surface, and the oblique pushing surface is formed around one end of the pushing member and configured to resist against the latching member.

14. The cylinder mechanism of claim 12, wherein the cylinder body assembly further comprises a bottom cover mounted to an end of the cylinder body which is opposite to the top cover.

15. The cylinder mechanism of claim 12, wherein the top cover comprises a fixing portion received in the receiving cavity and a guiding portion extending from the fixing portion, an extending hole is axially defined through the fixing portion and the guiding portion, the guiding portion protrudes out from the receiving cavity, and the guiding shaft is received through the extending hole, partially received in the receiving cavity, and protrudes out from the guiding portion.

16. The cylinder mechanism of claim 15, wherein a pair of fixing holes is defined in a sidewall of the fixing portion, and opposite ends of the pins are received in the pair of fixing holes, respectively.

17. The cylinder mechanism of claim 12, wherein the piston defines a fixing groove, the first end of the guiding shaft is fixed in the fixing groove.

18. The cylinder mechanism of claim 12, wherein the limiting member comprises a connection portion and a resisting portion extending from the connection portion, the resisting portion extends into the second receiving groove, and the connection portion is fixed to the second end of the guiding shaft.

19. The cylinder mechanism of claim 12, wherein each of the pair of guiding holes is elongated.

20. The cylinder mechanism of claim 12, wherein a size of an outer portion of the limiting hole decreases from an inner surface of the guiding shaft to an outer surface of the guiding shaft.
